(19) United States
(12) Patent Application Publication
(10) Pub. No.: US 2023/0189837 A1
(43) Pub. Date: Jun. 22, 2023

(54) FOODSTUFF

(71) Applicant: MARLOW FOODS LIMITED, Stokesley Yorkshire (GB)

(72) Inventors: Stewart RADFORD, Stokesley (GB); Olumuyiwa Adetokunbo AKINTOYE, Stokesley (GB)

(21) Appl. No.: 17/928,757

(22) PCT Filed: Jun. 15, 2021
(86) PCT No.: PCT/GB2021/051495

§ 371 Date: Nov. 30, 2022

(30) Foreign Application Priority Data
Jun. 18, 2020 (GB) 2009325.8

(51) Int. Cl. A23J 1/00; A23J 3/14; A23J 3/20; A23J 1/14

(52) U.S. Cl. CPC A23J 1/006; A23J 3/14; A23J 3/20; A23J 1/14

(57) ABSTRACT

A foodstuff that includes 15 to 40 wt % of said filamentous fungus on a dry matter basis; 0.5 to 5.0 wt % of potato protein; 50 to 80 wt % of water; and 0.5 to 5.0 wt % of a second protein ingredient which is derived from a plant.

This invention relates to a foodstuff and particularly, although not exclusively, relates to a foodstuff which incorporates potato protein.

It is known to use potato protein as a binder in vegan or vegetarian foodstuffs, for example in combination with a filamentous fungus. However, disadvantageously, whilst the number of foodstuffs and the market demand for such foodstuffs is increasing, there is a finite amount of potato protein available in the commercial market which means there is a risk that demand will exceed supply. There is therefore a risk that suppliers of such foodstuffs may, if demand continues to rise, be unable to meet such demand with currently used recipes for various foodstuffs.

It is an object of the present invention to address the above described problem.

The present invention is based upon the discovery that potato protein may be combined with other proteins which may not otherwise act as binders (or which are inherently poor binders) when used alone to produce vegan or vegetarian foodstuffs, but which can be mixed with potato protein to produce a combination which has rheological (eg binding) properties which are comparable to the properties of potato protein when used alone. Consequently, such other proteins may be combined with potato protein and used to produce vegan or vegetarian foodstuffs which use less potato protein, thereby optimising the amount of vegan or vegetarian foodstuffs that can be made using a finite amount of potato protein.

According to a first aspect of the invention, there is provided a foodstuff comprising potato protein and a second protein ingredient.

Said potato protein may be a native total potato protein isolate or a fraction of such an isolate. The term “native potato protein” as used in this application is meant to refer to the potato protein without any significant physical or (bio)chemical modification or inactivation, in particular denaturation. Existing methods for isolating potato proteins and potato protein fractions include fractionation, ion exchange, gel permeation, ultrafiltration, affinity and mixed-mode chromatography and fractionation by heat coagulation.

Said potato protein may include high levels of glycoprotein, for example greater than 30 wt % or greater than 40 wt %; and may include greater than 30 wt % or greater than 40 wt % of the glycoprotein patatin.

Potato tuber proteins can be classified in many different groups. Lindner et al. 1980 proposed to use a classification of potato proteins into just two separate groups; acid soluble and acid coagulable potato proteins. The acid coagulable fraction was shown by the author to be dominated by High Molecular Weight (HMW) proteins in the range of 32-87 kDa based on SDS-PAGE analysis.

Similarly the acid soluble protein fraction was shown to be dominated by Low Molecular Weight (LMW) proteins in the range of 17-27 kDa proteins. This classification in acid soluble and acid coagulable proteins at the same time groups acidic proteins (acid coagulable/HMW) from basic proteins (acid soluble/LMW) (Ralet & Gueguen 2000). It is understood Avebe NL typically produces these same two potato protein fractions under non-denaturing conditions by means of mixed-mode chromatography and the fractions are sold under the trade marks Solanic 200 and Solanic 300. However, a range of alternative purification methods can be used to obtain at least one of these native potato protein fractions. Native protein purification methods employ mild processing conditions to avoid denaturation and largely maintain the secondary and tertiary structure of the protein. These mild conditions avoid the use of extreme pH, temperature and other denaturation conditions in order to retain the solubility of the protein. The intrinsic biochemical characteristics of a specific protein fraction largely determines whether the protein is either sensitive or resistant to the conditions in the protein isolation process. For example the high molecular weight fraction is more thermal sensitive resulting in insoluble protein aggregates at temperatures of 30° C. or above. The low molecular weight fraction is more temperature resistant and can resist temperatures over 45° C. (Bartova 2008). Similarly, the high molecular weight fraction aggregates and precipitates at pH values in the range of 3 to 5 while the low molecular weight fraction is largely soluble in this pH range. This allows the use of pH or temperature or a combination thereof to specifically coagulate and subsequently precipitate one protein fraction while maintaining the native character of the other.

Preferably, said potato protein is a fraction of a potato protein isolate. Said potato protein is preferably an acid coagulable fraction of a potato protein isolate. Said potato protein is preferably a relatively high molecular weight fraction of a native potato protein. Said potato protein preferably has a molecular weight of at least 35 kDa. Said potato protein may have a solubility of greater than 50 g/l (and preferably less than 250 g/l) at pH greater than 6.5. Said potato protein may have a protein content (% on a dry matter basis) of greater than 90% or greater than 92%. The isoelectric point (pl) Is preferably less than 6.0 and is preferably in the range 4.8 to 5.2. Said potato protein preferably is negatively charged.

Said potato protein preferably has a glycoalkaloid concentration of less than 300 ppm.

Preferably, said second protein ingredient is selected such that a test mixture comprising 8 wt % of said potato protein on a dry weight basis, 8 wt % of said second protein ingredient on a dry weight basis and 84 wt % of deionised water has a maximum storage modulus (G′) in the temperature range 0 to 100° C. which is at least 5% of the storage modulus (G′) of a 16 wt % formulation of said potato protein alone, wherein, suitably, the test mixture and the 16 wt % formulation of said potato protein alone are prepared as described in Example 1 and the storage modulus (G′) is determined as described in Test 1. The second protein ingredient may be such that the maximum storage modulus of a formulation comprising 16 wt % of said second protein ingredient alone in water is less than the storage modulus of the test mixture and, preferably, the ratio defined as the maximum storage modulus in the temperature range 0 to 100° C. of said formulation comprising 16 wt % of said second protein ingredient divided by the storage modulus of said test mixture in the temperature range 0 to 100° C. is less than 0.001 or even less than 0.0005.

Preferably, said second protein ingredient is selected such that a test mixture comprising 8 wt % of said potato protein on a dry weight basis, 8 wt % of said second protein ingredient on a dry weight basis and 84 wt % of deionised water has a maximum storage modulus (G′) at 80° C. which is at least 5% of the storage modulus (G′) of a 16 wt % formulation of said potato protein alone at 80° C., wherein, suitably, the test mixture and the 16 wt % formulation of said potato protein alone are prepared as described in Example 1 and the storage modulus (G′) is determined as described in Test 1. The second protein ingredient may be such that the maximum storage modulus of a formulation comprising 16 wt % of said second protein ingredient alone in water at 80° C. is less than the storage modulus of the test mixture and, preferably, the ratio defined as the maximum storage modulus at 80° C. of said formulation comprising 16 wt % of said second protein ingredient divided by the storage modulus of said test mixture at 80° C. is less than 0.001 or even less than 0.0005.

Said second protein ingredient is preferably non-animal derived.

Said second protein ingredient may be derived from a plant or a fungus, for example a yeast.

Said second protein ingredient may comprise a globular protein. Preferably, said second protein ingredient is derived from a plant.

Said second protein ingredient is preferably not a potato protein and/or does not include potato protein.

Said second protein ingredient is preferably selected from the group comprising legumes (pulses) (eg Pea (Pisum sativum), Lentil (Lens culinais), Chickpea (Cicer arietinum), Mung bean (Phaseolus aureus), Broad/faba/fava bean (Vicia faba)), oil seeds (eg Canola (Brassica napus), Sunflower (Helianthus annus), Flax (Linum usitatissimum), Hemp (Cannabis sativa). Soybean (Glycine max), Pumpkin) and cereals (eg Wheat (Triticum), Rice (Oryza), Quinoa (Chenopodium), Chia (Salvia), Amaranth (Amaranthus)).

Said second protein ingredient is preferably a protein, for example a globular protein, suitably derived from a legume or a cereal and/or may be derived from a fruit or seed. Said second protein ingredient may be a soluble or colloidal suspended globular protein.

A preferred legume may comprise a pea, bean or seed. For example, a preferred legume may be pea, faba bean, mung bean, chickpea, hemp seed, lentil, sunflower seed or pumpkin seed.

A preferred cereal is wheat and said second protein ingredient may comprise wheat gluten.

Said second protein ingredient is preferably a storage protein. Said second protein ingredient may include one or more proteins selected from the group comprising albumins, legumins, prolamins, glutelins and vicilin; and, preferably, said second protein ingredient includes at least 50 wt %, more preferably at least 80 wt %, of proteins selected from those in said defined group.

The second protein ingredient may be in the form of a protein concentrate or protein isolate. A protein concentrate suitably refers to a protein material that is obtained from a natural material upon removal of soluble carbohydrate, ash and other minor constituents. It may have at least 40% protein on a dry weight basis. A protein isolate may be obtained from a natural material by removal of insoluble polysaccharide, soluble carbohydrate, ash and other minor constituents. It may include at least 60% protein on a dry weight basis.

Said second protein ingredient may be selected from a group (referred to herein as “Group XX”) of ingredients as follows:]
(i) a puree (e.g., bean puree, pumpkin puree, applesauce, yam puree, banana puree, plantain puree, date puree, prune puree, fig puree, zucchini puree, carrot puree, coconut puree);
(ii) flours derived from grains or legumes or roots (e.g., from taro, banana, jackfruit, konjac, lentil, fava, lupin bean, pea, bean, rice, wheat, barley, rye, corn, sweet rice, soy, teff, buckwheat, amaranth, chickpea, sorghum, almond, chia seed, flaxseed, potato, tapioca, potato);
(ii) protein isolates (e.g., from potato, soy, pea, lentil, chickpea, lupin, oat, canola, wheat);
(iv) hydrolyzed protein isolates (e.g., hydrolyzed pea protein isolate, hydrolyzed soy protein isolate, hydrolysed wheat gluten);
(v) protein concentrates (e.g. from algae, lentil, pea, soy, chickpea, rice, hemp, fava bean, pigeon pea, cowpea, vital wheat gluten);
(vi) native or relatively folded (i.e., not fully in the native functional state but not fully denatured) proteins (e.g., fava protein, lentil protein, pea protein, ribulose-1,5-bisphosphate carboxylase/oxygenase [Rubisco], chickpea protein, mung bean protein, pigeon pea protein, lupin bean protein, soybean protein, white bean protein, black bean protein, navy bean protein, adzuki bean protein, sunflower seed protein).

In a preferred embodiment, said second protein ingredient is selected from pea protein, wheat protein, faba bean protein, mung bean protein, hemp seed protein, chickpea protein, lentil protein, sunflower seed protein, pumpkin seed protein and yeast protein. The second protein ingredient may comprise a protein isolate or a protein concentrate.

Unless otherwise stated herein, amounts of potato protein and/or second protein ingredient are stated on a dry matter basis.

A first ratio defined as the wt % of said potato protein divided by the wt % of said second protein ingredient may be at least 0.4 or at least 0.6. Said first ratio is preferably at least 0.8, more preferably, at least 0.9 or, especially, at least 1.0. Said ratio may be less than 10.0, less than 7.0 or less than 5.0. Said first ratio is preferably in the range 0.5 to 2.5, more preferably in the range 0.7 to 1.5, especially in the range 0.8 to 1.5 or in the range 0.8 to 1.2. It has been found that a mixture comprising potato protein and said second protein ingredient has an unexpectedly high storage modulus (G¹) as hereinafter described, suggesting that the potato protein acts synergistically with the second protein ingredient. Consequently, lower amounts of potato protein may be utilised in the foodstuff, whilst achieving acceptable storage modulus (G¹).

Said foodstuff may include at least 0.5 wt % or at least 1 wt % or at least 1.5 wt % of potato protein. Said foodstuff may include less than 10 wt %, suitably less than 5.0 wt %, preferably less than 3.0 wt %, more preferably less than 2.0 wt %, especially less than 1.8 wt % of potato protein. Preferably, said foodstuff includes 0.5 to 3 wt %, more preferably 1.0 to 2.5 wt % of said potato protein.

Said foodstuff may include at least 0.4 wt % or at least 0.7 wt % or at least 1.0 wt % or at least 1.5 wt % of second protein ingredient. Said foodstuff may include less than 10 wt %, suitably less than 5.0 wt %, preferably less than 3.0 wt %, more preferably less than 2.0 wt %, especially less than 1.8 wt % of second protein ingredient. Preferably, said foodstuff includes 0.5 to 3 wt %, more preferably 0.7 to 2.5 wt % of said second protein ingredient.

Said foodstuff may include a third protein ingredient which is preferably not a filamentous fungus. Said third protein ingredient is suitably different from said second protein ingredient but may otherwise have any feature of said second protein ingredient described herein. Thus, said third protein ingredient is preferably non-animal derived. Said third protein ingredient may be derived from a plant or a fungus, for example a yeast. Preferably, said third protein ingredient is derived from a plant.

Said third protein ingredient is preferably not a potato protein and/or does not include potato protein.

Said third protein ingredient is preferably derived from a legume or a cereal and/or may be derived from a fruit or seed. A preferred legume may comprise a pea, bean or seed. For example, a preferred legume may be pea, faba bean, mung bean, chickpea, hemp seed, lentil, sunflower seed or pumpkin seed.

A preferred cereal is wheat.

The third protein ingredient may be in the form of a protein concentrate or protein isolate.

Said third protein ingredient may be selected from Group XX referred to above.

The sum of the wt % of said second protein ingredient and the wt % of said third protein ingredient in said foodstuff may be referred to as “protein sum (P1)”. A second ratio defined as the wt % of said potato protein divided by the wt % of said protein sum (P1) may be at least 0.4 or at least 0.6. Said second ratio is preferably at least 0.8, more preferably at least 0.9 or, especially, at least 1.0. Said second ratio may be less than 10.0, less than 7.0 or less than 5.0. Said second ratio is preferably in the range 0.5 to 2.5, more preferably in the range 0.7 to 1.5, especially in the range 0.8 to 1.5 or in the range 0.8 to 1.2.

The sum of the wt % of said second protein ingredient and all other protein-containing ingredients in said foodstuff excluding any filamentous fungus in said foodstuff may be referred to as the “protein sum (P2)”. A third ratio defined as the wt % of said potato protein divided by the wt % of said protein sum (P2) may be at least 0.4 or at least 0.6. Said third ratio is preferably at least 0.8, more preferably at least 0.9 or, especially, at least 1.0. Said third ratio may be less than 10.0, less than 7.0 or less than 5.0. Said third ratio is preferably in the range 0.5 to 2.5, more preferably in the range 0.7 to 1.5, especially in the range 0.8 to 1.5 or in the range 0.8 to 1.2.

Said foodstuff may include 10 to 95 wt %, for example 50 to 95 wt %, of added edible filamentous fungus on a wet matter basis. Said “wet” filamentous fungus is suitably mycoprotein paste referred to hereinafter. Said foodstuff may include 80 to 95 wt % of added filamentous fungus on said wet matter basis.

Said foodstuff may include at least 2 wt %, for example at least 6 wt % or at least 12 wt % of said filamentous fungus on a dry matter basis. Said foodstuff may include at least 16 wt %, preferably at least 20 wt % of said filamentous fungus on a dry matter basis. Said foodstuff may include less than 24 wt %, preferably less than 22 wt % of said filamentous fungus on a dry matter basis.

Said foodstuff may include 2 to 24 wt %, preferably 12 to 24 wt %, more preferably 16 to 23 wt % of said filamentous fungus on a dry matter basis.

In said foodstuff, a third ratio defined as the weight of filamentous fungus on a dry matter basis divided by the weight of potato protein may be at least 1, is suitably at least 5, preferably at least 7, more preferably at least 10. Said third ratio may be less than 20, suitably less than 15.

Said third ratio may be in the range 1 to 20, suitably in the range 5 to 20, preferably in the range 7 to 15, more preferably in the range 10 to 15.

In said foodstuff, a fourth ratio defined as the weight of filamentous fungus on a dry matter basis divided by the weight of second protein ingredient may be at least 1, suitably at least 5, preferably at least 7, more preferably at least 10. Said fourth ratio may be less than 20, suitably less than 15.

Said edible filamentous fungus preferably comprises fungal particles. Said filamentous fungus preferably comprises fungal mycelia and suitably at least 80 wt %, preferably at least 90 wt %, more preferably at least 95 wt % and, especially, at least 99 wt % of the fungal particles in said foodstuff comprise fungal mycella. Some filamentous fungi may include both fungal mycelia and fruiting bodies. Said fungal particles preferably comprise a filamentous fungus of a type which does not produce fruiting bodies. Where, however, a filamentous fungus of a type which produces fruiting bodies is used, the fungal particles in said foodstuff suitably include at least 80 wt %, preferably at least 90 wt %, more preferably at least 95 wt % of fungal mycelia. Preferably, said fungal particles comprise substantially only fungal mycelia—that is, said fungal particles in said foodstuff preferably do not include any fruiting bodies.

Preferred fungi for said fungal particles have a cell wall which includes chitin and/or chitosan. Preferred fungi have a cell wall which includes polymeric glucosamine. Preferred fungi have a cell wall which includes 01-3 and 1-6 glucans.

Said fungal particles preferably comprise (preferably consist essentially of) fungus, for example selected from fungi imperfecti.

Preferably, said fungal particles comprise, and preferably consist essentially of, cells of Fusarium species, especially of Fusarium venenatum A3/5 (formerly classified as Fusarium graminearum) (IMI 145425; ATCC PTA-2684 deposited with the American Type Culture Collection, 10801 University Boulevard, Manassas, Va.) as described for example in WO96/21361 (Zeneca) and WO95/23843 (Zeneca).

Preferably, said fungal particles are non-viable. Preferably, said fungal particles have been treated to lower the level of RNA which they contain. Thus, the level of RNA in the fungal particles used is preferably less than the level in an identical fungus when in a viable state.

The level of RNA in the fungal particles is preferably less than 2 wt % on a dry matter basis.

Fungal particles in said foodstuff may comprise filaments having lengths of less than 1000 μm, preferably less than 800 μm. Said filaments may have a length greater than 100 μm, preferably greater than 200 μm. Preferably, fewer than 5 wt %, preferably substantially no, fungal particles in said foodstuff have lengths of greater than 5000 μm; and preferably fewer than 5 wt %, preferably substantially no, fungal particles have lengths of greater than 2500 μm. Preferably, values for the number average of the lengths of said fungal particles in said foodstuff are also as stated above.

Fungal particles in said foodstuff may comprise filaments having diameters of less than 20 μm, preferably less than 10 μm, more preferably 5 μm or less. Said filaments may have diameters greater than 1 μm, preferably greater than 2 μm. Preferably, values for the number average of said diameters of said fungal particles in said foodstuff are also as stated above.

Fungal particles in said foodstuff may comprise filaments having an aspect ratio (length/diameter) of less than 1000, preferably less than 750, more preferably less than 500, especially of 250 or less. The aspect ratio may be greater than 10, preferably greater than 40, more preferably greater than 70. Preferably, values for the average aspect ratio of said fungal particles (i.e. the average of the lengths of the particles divided by the average of the diameters of the fungal particles) In said foodstuff are also as stated above.

In said foodstuff, a fifth ratio defined as the weight of water divided by the weight of filamentous fungus on a dry matter basis may be in the range 3.0 to 3.5.

The total amount of water in said foodstuff may be at least 50 wt %, preferably at least 60 wt %, more preferably at least 65 wt %. The total amount of water may be less than 80 wt % or less than 75 wt %.

The total amount of water in said foodstuff may be in the range 60 to 75 wt %.

Preferably, the sum of the wt % of said filamentous fungus on a dry matter basis, said potato protein, water and said second protein ingredient is at least 90 wt %, preferably at least 92 wt %. It may be less than 97 wt %.

Said foodstuff may include:

15 to 40 wt % of said filamentous fungus on a dry matter basis;

0.5 to 5.0 wt % of potato protein;

50 to 80 wt % of water; and

0.5 to 5.0 wt % of said second protein ingredient.

Preferably, said foodstuff includes:

17 to 33 wt % of said filamentous fungus on a dry matter basis;

1.0 to 4.0 wt % of potato protein;

60 to 80 wt % of water; and

0.7 to 3.0 wt % of said second protein ingredient.

Said foodstuff may include other ingredients. The foodstuff may include one or more ingredients added to adjust the pH of the foodstuff. Preferably, the foodstuff includes an acidulant. Said foodstuff may include at least 0.5 wt % of acidulant. It may include less than 2 wt % of acidulant. The foodstuff may include one or more flavourants. In said foodstuff, the total amount of added flavourants may be at least 0.5 wt %, preferably at least 1 wt %. The total amount may be less than 4 wt %. Said foodstuff may include a preservative at a level of less than 0.25 wt %. It may include at least 0.05 wt % of said preservative.

Said foodstuff preferably includes less than 5 wt %, preferably 0 wt %, of ingredients of animal origin.

Said foodstuff is preferably suitable for vegans. It preferably includes 0 wt % of components derived from animals.

Said foodstuff is preferably a meat-substitute which suitably includes no meat.

According to a second aspect of the invention, there is provided a process for making a foodstuff, the process comprising:

(i) selecting particles of filamentous fungus;

(ii) selecting potato protein and a second protein ingredient;

(iii) contacting said particles of filamentous fungus with said potato protein and said second protein ingredient.

Said foodstuff may have any feature of the foodstuff of the first aspect. Said filamentous fungus may have any feature of said filamentous fungus of the first aspect. Said potato protein may have any feature of the potato protein of the first aspect. Said second protein ingredient may have any feature of the second protein ingredient of the first aspect.

In step (i) a biomass comprising filamentous fungus is suitably selected. Said biomass may be in the form of a paste. Said biomass may include 20-30 wt %, (preferably 22-26 wt %) of filamentous fungus on a dry matter basis and 70-80 wt %, (preferably 74 to 78 wt %) of water.

Said potato protein is suitably in a powder form. Said second protein ingredient is suitably in a powder form.

Said particles of filamentous fungus may be contacted with said potato protein and said second protein ingredient.

The process may comprise selecting 30 to 95 wt %, preferably 70 to 90 wt %, more preferably 75 to 85 wt % of said biomass and contacting it with 0.5 to 5 wt % potato protein and 0.5 to 5 wt % of said second protein ingredient.

Other ingredients (e.g. additional water, flavourants, preservatives and/or acidulant) may also be contacted with filamentous fungus in step (iii) or subsequent thereto.

In step (iii), said particles of filamentous fungus, and other ingredients hydrocolloid are preferably mixed, suitably to produce a substantially homogenous mass.

Any feature of any aspect of any invention described herein may be combined with any feature of any other invention described herein mutais mutandis.

Specific embodiments of the invention will now be described, by way of example, with reference to the accompanying drawings, in which:

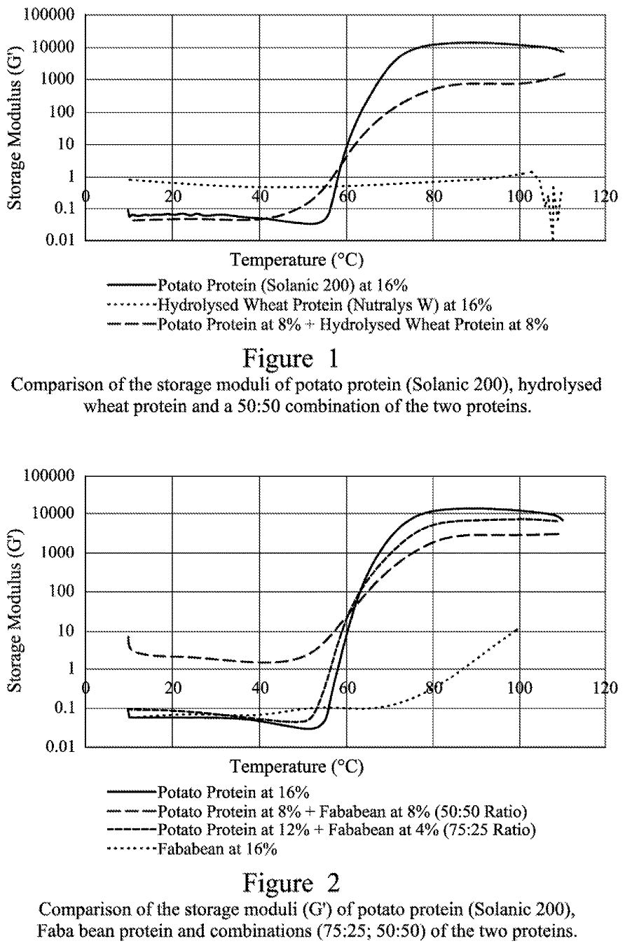

FIG. 1 is a graph comparing storage moduli of potato protein, hydrolysed wheat protein and a combination of the two proteins;

FIG. 2 is a graph comparing storage moduli (G′) of potato protein, Faba bean protein and combinations of the two proteins; and

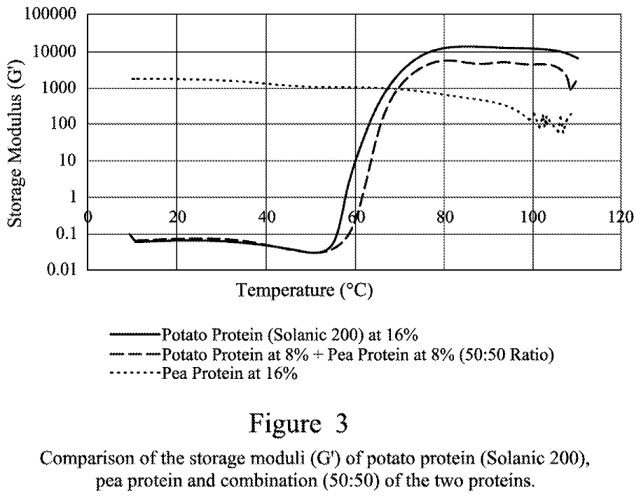

FIG. 3 is a graph comparing storage moduli (G′) of potato protein, pea protein and a combination of the two proteins.

The following materials are referred to hereinafter:

Mycoprotein paste —Mycoprotein paste-refers to a visco-elastic material comprising a mass of edible filamentous fungus derived from Fusarium venenatum A3/5 (formerly classified as Fusarium graminearum Schwabe) (IMI 145425; ATCC PTA-2684 deposited with the American type Culture Collection, 12301 Parklawn Drive, Rockvllle Md. 20852) and treated to reduce its RNA content to less than 2% by weight by heat treatment. Further details on the material are provided in WO96/21362 and WO95/23843. The material may be obtained from Marlow Foods Limited of Stokesley, U.K. It comprises about 23-25 wt % solids (the balance being water) made up of non-viable RNA reduced fungal hyphae of approximately 400-750 μm length, 3-5 μm in diameter and a branching frequency of 2-3 tips per hyphal length. The paste has a viscosity, measured as described below, at 800 Pa and 10° C. of 10.462 Pa/s.

Solanic 200 potato protein—potato protein obtained from Avebe NL having molecular weight in the range 4 to 35 kDa, a protein content of >95% on a dry weight basis. The product may be prepared as described in WO2019088834 for example at page 3 line 20 to line 33 (the content of which is hereby incorporated by reference) and more specifically at page 10 line 21 to page 11, line 13 (the content of which is hereby incorporated by reference)

Nutralys W—a high solubility, low viscosity, hydrolysed wheat protein obtained from Roquette Frères.

Faba bean protein—refers to Faba bean 60 protein concentrate obtained from AGT Poortman.

Pea protein—commercially available pea protein.

The following tests are referred to herein:

Test 1—Rheological Analysis —Assessment of Storage Modulus Modulus (G′)

Rheological analysis was performed using a Kinexus Lab+ Rheometer (NETZSCH-Gerätebau GmbH) with a C25 SS Cup and Bob geometry. The rheometer was initiaflsed, gap zeroed and calibrated. The rheological sequence used for analysis of the sample was a single frequency strain with controlled temperature ramp. The sequence was used to determine the change in storage modulus modulus (G′) (a rheological indicator of solid, gel-like character) of a sample across a temperature ramp. The following steps were undertaken:

1 Turn on the Rheometer in the order —compressed air line, rheometer, cooling unit, PC. All obstructions and attachments were removed and the rheometer hood was allowed to initialise.

2 The software was opened and the file M029 Gelation Method was selected. The rheometer was prepared using the test parameter table below.

3 The rheology geometry was set up, using the C25 SS Cup and Bob. This was secured in place with the geometry clip on the rheometer base.

4 The steps on the software (Space Kinexus software) was followed and the geometry zero gapped. Then 5 ml of the liquid gel mixture to be tested was micropipetted into the cup.

5 Once the bob had been lowered into position, any excess gel mixture and bubbles were removed.

6 The solvent lid was placed over the geometry and then the sample was ready for analysis.

Testing parameters used in the rheological gel analysis of protein binder systems are shown in the table below. The ‘ramp end temperature’ varies dependent on the type of binders present in the gel system.

| Ramp Start Temperature (° C.) | 10(° C.) | |
|---|---|---|
| Ramp End Temperature (° C.) | 110(° C.) | |
| Ramp Rate (° C./minute) | 5° | C./minute |
| Frequency (Hz) | 1 | Hz |

| | |
|---|---|
| Shear Strain (%) | 1.00% |
| Sampling Interval | 0:00:00:05 |

In the following examples, example 1 describes preparation of samples, examples 2 to 17 describe combinations of potato protein and other proteins and comparisons of storage moduli thereof, examples 18 to 21 describe preparation of foodstuffs and example 22 describes the tasting and/or comparison of such foodstuffs.

### EXAMPLE 1—GENERAL METHOD FOR PREPARING SAMPLES OF PURE PROTEINS AND COMBINATIONS OF PROTEINS FOR EVALUATION OF RHEOLOGICAL PROPERTIES

The standard total powder percentage used in water to prepare a gel was 16 wt %. As a first step, a selected amount of plant protein binder was weighed into a Stomacher bag. If a single protein is used to produce a gel, then a total 16.00 g of protein is weighed out (±0.01 g). If a mixture of proteins is used to produce a gel, then proteins are weighed out in appropriate ratios to produce 16.00 g (±0.01 g) of protein in total.

A micropipette was used to add 84.00 g (±0.01 g) (84 wt % of total mix) of de-ionised water to the plant protein binder(s) in the Stomacher bag. The contents of the bag were not mixed or disrupted until later Stomaching. Immediately after addition of the de-ionised water, the Stomacher bag was placed in the Stomacher machine (a Seward 400 Stomacher) for a total of four minutes at 230 rpm.

The gel mixture was removed from the Stomacher machine and left in the bag to rest for 30 minutes (to allow for foam to dissipate).

After 30 minutes of rest, the gel mixture from the Stomacher bag was poured into a glass beaker and placed on a magnetic stirrer platform. The stirrer was turned on at a low level (1). The pH of the gel mixture was adjusted to a pH level of 6.00 (±0.05) whilst stirring. The beaker was then removed from the stirrer and left to rest for a further 30 minutes. Thereafter, the gel mixture was ready for analysis.

### EXAMPLES 2—COMPARISON OF THE STORAGE MODULI OF POTATO PROTEIN, HYDROLYSED WHEAT PROTEIN AND A COMBINATION OF THE TWO PROTEINS

Three samples were prepared as described in Example 1. A first sample comprised Solanic 200 alone (16 wt % in water); a second sample comprised hydrolysed wheat protein (Nutralys W) (16 wt % in water); and a third comprised a 50:50 combination of the two proteins (Solanic 200 and Nutralys W) (16 wt % total protein in water). The G′ was assessed over a temperature range of 10-110° C. as described in Test 1. Results are provided in FIG. 1.

Referring to the figure, the first sample (potato protein solution (16 wt. %)) had a storage modulus signal which reaches a maximum G′ (˜10 000 Pa) at around 80° C., which indicates a firm, set, solid gel. Ideally, any replacement mixture would also attain a similar gel strength. The second sample (hydrolysed wheat protein (16 wt. %)) by comparison has a very low storage modulus (˜1 Pa) that remains unchanged despite an increase in temperature. This second sample essentially does not gel. However, the third sample (a 50:50 combination of hydrolysed wheat protein and potato protein) does appear to gel and reaches a maximum storage modulus of ˜1000 Pa which is found to be sufficiently high to be used in formulated foodstuffs.

### EXAMPLES 3—COMPARISON OF THE STORAGE MODULI OF POTATO PROTEIN, FABA BEAN PROTEIN AND A COMBINATION OF THE TWO PROTEINS

The first sample described in Example 1 was used as a baseline. In addition, a second sample comprised Faba bean protein concentrate (16 wt % in water); a third comprised a 50:50 combination of the two proteins (Solanic 200 and Faba bean) (16 wt % total protein in water); and a fourth comprised a 75:25 combination of the two proteins (Solanic 200 and Faba bean) (16 wt % total protein in water. The G′ was assessed over a temperature range of 10-110° C. as described in Test 1. Results are provided in FIG. 2.

Referring to the figure, the Faba bean solution (16 wt. %) reaches a maximum storage modulus value of 10 Pa which indicates it is a very soft, weak gel. In contrast, the mixtures of potato-Faba bean protein attain a storage modulus of ˜10000 Pa (75:25 potato-Faba bean mixture, close to the potato protein reference) and >1000 Pa (50:50 potato-Faba been mixture). The mixtures form moderate to firm gels which are found to be sufficiently high to be used in formulated foodstuffs.

### EXAMPLES 4—COMPARISON OF THE STORAGE MODULI (G′) OF POTATO PROTEIN, PEA PROTEIN AND COMBINATIONS OF THE TWO PROTEINS

The first sample described in Example 1 was used as a baseline. In addition, a second sample comprised pea protein (16 wt % in water); and a third comprised a 50:50 combination of the two proteins (Solanic 200 and pea protein) (16 wt % total protein in water). The G′ was assessed over a temperature range of 10-110° C. as described in Test 1. Results are provided in FIG. 3.

Referring to the figure, the pea protein alone forms a gel (1000 Pa) from the start, but this softens as it is heated past 60° C. to a reduced storage modulus of 100 Pa at ˜100° C. However, in combination with potato protein (50:50 ratio), the storage modulus reaches ˜5 000 Pa which is found to be sufficiently high to be used in formulated foodstuffs as described in Examples 19 to 21.

### EXAMPLES 5 TO 17—OTHER COMBINATIONS COMPRISING SOLANIC 200 AND ANOTHER PROTEIN

Following the procedure described above, other combinations comprising Solanic 200 and another protein were assessed as described. The proteins in the table below were found to give sufficiently high G′ and acceptable texture when used in foodstuffs.

| | | Example ratio |
|---|---|---|
| | | (Solanic 200:second |
| | Protein combined | protein ingredient) for |
| Example No. | with Solanic 200 | acceptable texture |
| 5 | Pea protein | 50:50 |
| | isolate, >80% | |
| | protein content | |
| 6 | Wheat protein | 50:50 |
| | (hydrolysed, >70% | |
| | protein) (Nutralys) | |
| 7 | Faba bean | 75:25 |
| | concentrate (60% protein) | |
| 8 | Faba bean isolate | 75:25 |
| | (>80% protein). | |
| 9 | Australian Faba bean protein | 50:50 |
| | isolate (>80% protein) | |
| 10 | Mung bean isolate | 50:50 |
| | (>80% protein), | |
| 11 | Mung bean | 50:50 |
| | concentrate | |
| | (60% protein), | |
| 12 | Hemp seed protein | 50:50 |
| | (>60% protein) | |
| 13 | Chickpea protein | 50:50 |
| | isolate (>80% protein) | |
| 14 | Lentil protein | 50:50 |
| | isolate (>80% protein), | |
| 15 | Sunflower seed | 50:50 |
| | protein (>40% protein) | |
| 16 | Pumpkin seed protein | 50:50 |
| | (>60% protein) | |
| 17 | Yeast protein isolate | 50:50 |
| | (>80% protein), | |

### EXAMPLE 18—GENERAL PROCEDURE FOR PREPARATION OF FOODSTUFFS

Firstly, any dry/powdered ingredients (eg calcium acetate, carrageenan, fibre, wheat gluten, flavour, potato protein, alternative protein) were weighed into separate containers and set aside temporarily. Next, moist/wet ingredients (eg mycoprotein paste, calcium chloride solution, water) were measured out into separate containers.

Next, the moist ingredients were added to a batch mixer bowl and mixed on medium speed until well mixed (2-3 minutes). The pre-weighed dry ingredients were introduced into the mixer bowl and mixed slowly, until well mixed (up to 5 minutes). The edges & bottom of mixing bowl may be occasionally scraped to ensure ingredients are evenly mixed. Further mixing may be undertaken until everything is mixed in thoroughly. The mixer bowl may be upturned and the ‘dough’ scooped out onto a baking try and shaped into an oblong shape to a uniform depth (2 cm).

The baking tray may be placed into an industrial steam oven and cooked for 30 minutes at 97° C. The tray may be removed after 30 minutes and allowed to cool slightly (up to 5 mins) to allow excess steam to flash off.

The baking tray may then be placed in an industrial blast freezer (at −20° C.) for 30 minutes or until a cheese-ike, cutable texture (part frozen) is produced.

The product may be removed from the blast freezer and cut into cubes/pieces (1-1.5 cm length). The cubed product may be placed into plastic sample bags and placed back into the industrial blast freezer unit (at −20° C.), until fully frozen (up to 1 further hour).

The sample bags may be removed from the blast freezer and placed into long term deep freezer storage (industrial freezer warehouse at −30° C.). The product is left to age, under freezing conditions for at lest 2 weeks prior to further processing and assessment.

### EXAMPLES 19 TO 21—PREPARATION OF FOODSTUFFS

Following the general procedure described in Example 18, foodstuffs (nuggets for vegans) having the ingredients referred to in Example 19 to 21 were prepared. Example 19 includes only a single protein (potato protein) for comparison with Examples 20 and 21).

| | Example No. | | |
|---|---|---|---|
| | 19 | 20 | 21 |
| | 100% Potato | Potato Protein | Potato Protein |
| | Protein | Reduced (50:50) | Reduced (75:25) |
| | Vegan Nuggets | Vegan Nuggets | Vegan Nuggets |
| Ingredients | % | % | % |
| Mycoprotein | 89.83 | 89.82 | 89.82 |
| paste | | | |
| Water | 1.50 | 1.50 | 1.50 |
| Natural flavour | 1.11 | 1.11 | 1.11 |
| Potato protein | 3.33 | 1.67 | 2.47 |
| Pea Protein | 0.00 | 1.67 | 0.83 |
| Wheat gluten | 1.11 | 1.11 | 1.11 |
| Calcium Acetate | 0.44 | 0.44 | 0.44 |
| Calcium Chloride | 1.17 | 1.17 | 1.17 |
| liquid (36 wt % | | | |
| calcium chloride | | | |
| solids; balance | | | |
| water) | | | |
| Carrageenan | 0.44 | 0.44 | 0.44 |
| Pea Fibre | 0.97 | 0.97 | 0.97 |
| Sodium Alginate | 0.09 | 0.09 | 0.09 |
| TOTAL | 100.00 | 100.00 | 100.00 |

### EXAMPLE 22—FOODSTUFF PREPARATION FOR TASTING PROTOCOL

Samples of the foodstuffs are removed from deep freeze storage, referred to in Example 18, and set-aside at room temperature, to allow the sample to slightly defrost and allow individual cubes/pieces to be manipulated. Vegetable oil is added to the surface of a fryer and allowed to warm up. A quantity of product cubes are added to the fryer and moved so they become coated with vegetable oil. The core cubed product temperature is monitored with a temperature probe and the frying process is continued until a minimum core temperature of 75° C. is attained. The cooked product is removed from the fryer and place onto plates ready for immediate sensory tasting.

### EXAMPLE 23—COMPARISON OF SENSORY ATTRIBUTES OF THE FOODSTUFFS OF EXAMPLES 19 TO 21

The sensory attributes of the foodstuffs of Examples 19 to 21 were assessed using proprietary tests and the foodstuffs of Examples 20 and 21 were found to perform at the level of the foodstuff of Example 19 (and to other relevant, commercially available foodstuffs) and, accordingly, it was concluded that the foodstuffs as described are commercially acceptable, despite the reduced level of potato protein.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A foodstuff comprising potato protein and a second protein ingredient.

2. (canceled)

3. The foodstuff according to claim 1, wherein said potato protein is acid coagulable fraction of a potato protein isolate and has a molecular weight of at least 35 kDa.

4. (canceled)

5. (canceled)

6. The foodstuff according to claim 1, wherein said second protein ingredient comprises a globular protein which is derived from a plant; and said second protein ingredient is not a potato protein.

7. (canceled)

8. (canceled)

9. (canceled)

10. (canceled)

11. The foodstuff according to claim 6, wherein said second protein ingredient is selected from pea protein, wheat protein, faba bean protein, mung bean protein, hemp seed protein, chickpea protein, lentil protein, sunflower seed protein, pumpkin seed protein and yeast protein.

12. The foodstuff according to claim 1, wherein a first ratio defined as the wt % of said potato protein divided by the wt % of said second protein ingredient is in the range 0.8 to 1.2.

13. The foodstuff according to claim 12, wherein said foodstuff includes 1.0 to 2.5 wt %, of said potato protein.

14. The foodstuff according to claim 1, wherein said foodstuff includes 0.5 to 3 wt % of said second protein ingredient.

15. The foodstuff according to claim 1, wherein the sum of the wt % of said second protein ingredient and all other protein-containing ingredients in said foodstuff excluding any filamentous fungus in said foodstuff is referred to as the “protein sum (P2)”, wherein a third ratio defined as the wt % of said potato protein divided by the wt % of said protein sum (P2) is in the range 0.5 to 2.5.

16. The foodstuff according to claim 15, wherein said foodstuff includes 10 to 95 of filamentous fungus on a dry matter basis.

17. The foodstuff according to claim 16, wherein, in said foodstuff, a third ratio defined as the weight of filamentous fungus on a dry matter basis divided by the weight of potato protein is in the range 1 to 20.

18. The foodstuff according to claim 16, wherein a fourth ratio is defined as the weight of filamentous fungus on a dry matter basis divided by the weight of second protein ingredient and said fourth ratio is in the range 1 to 20.

19. The foodstuff according to claim 18, wherein said mass comprises particles of said filamentous fungus (herein also referred to as “fungal particles”) and said fungal particles comprise cells of Fusarium species.

20. The foodstuff according to claim 19, wherein the level of RNA in the fungal particles is less than 2 wt % on a dry matter basis.

21. The foodstuff according to claim 16, wherein a fifth ratio defined as the weight of water divided by the weight of filamentous fungus on a dry matter basis in said foodstuff is in the range 3.0 to 3.5; and the total amount of water in said foodstuff is at least 50 wt %.

22. The foodstuff according to claim 16, wherein the sum of the wt % of said filamentous fungus on a dry matter basis, said potato protein, water and said second protein ingredient is at least 90 wt %.

23. The foodstuff according to claim 16, wherein said foodstuff includes:
15 to 40 wt % of said filamentous fungus on a dry matter basis;
0.5 to 5.0 wt % of potato protein;
50 to 80 wt % of water; and
0.5 to 5.0 wt % of said second protein ingredient.

24. The foodstuff according to claim 16, wherein said foodstuff includes:
17 to 33 wt % of said filamentous fungus on a dry matter basis;
1.0 to 4.0 wt % of potato protein;
60 to 80 wt % of water; and
0.7 to 3.0 wt % of said second protein ingredient.

25. The foodstuff according to claim 24, wherein said foodstuff includes 0 wt % of ingredients of animal origin and is a meat-substitute.

26. A process for making a foodstuff according to claim 23, the process comprising:
(i) selecting particles of filamentous fungus;
(ii) selecting potato protein and a second protein ingredient;
(iii) contacting said particles of filamentous fungus with said potato protein and said second protein ingredient; wherein the process comprises selecting 30 to 95 of said biomass and contacting it with 0.5 to 5 wt % potato protein and 0.5 to 5 wt % of said second protein ingredient.

27. (canceled)

28. (canceled)

29. A foodstuff which includes:
17 to 33 wt % of filamentous fungus on a dry matter basis;
1.0 to 420.0 wt % of potato protein;
60 to 80 wt % of water; and
0.7 to 3.0 wt % of a second protein ingredient;
wherein:
a first ratio defined as the wt % of said potato protein divided by the wt % of said second protein ingredient is in the range 0.8 to 1.2; and/or
the sum of the wt % of said second protein ingredient and all other protein-containing ingredients in said foodstuff excluding any filamentous fungus in said foodstuff is referred to as the “protein sum (P2)”, wherein a ratio defined as the wt % of said potato protein divided by the wt % of said protein sum (P2) is in the range 0.8 to 1.2; and/or
a third ratio defined as the weight of filamentous fungus on a dry matter basis divided by the weight of potato protein is in the range 10 to 15; and/or
a fourth ratio is defined as the weight of filamentous fungus on a dry matter basis divided by the weight of second protein ingredient is in the range 10 to 15.
